(19) United States
(12) Patent Application Publication
(10) Pub. No.: US 2004/0123112 A1
(43) Pub. Date: Jun. 24, 2004

(54) Security object providing encryption scheme and key

(75) Inventors: Benjamin Andrew Himmel, Yorktown Heights, NY (US); Maria Azua Himmel, Yorktown Heights, NY (US); Herman Rodriguez, Austin, TX (US); Newton James Smith JR., Austin, TX (US)

Correspondence Address: Biggers & Ohanian, PLLC, 5 Scarlet Ridge, Austin, TX, 78737, US

(73) Assignee: INTERNATIONAL BUSINESS MACHINES CORPORATION, ARMONK, NY

(21) Appl. No.: 10/324,497

(22) Filed: Dec. 19, 2002

(51) Int. Cl. H04L 9/00

(52) U.S. Cl. 713/182

(57) ABSTRACT

Controlling access to a resource, including creating a security object in dependence upon user-selected security control data types, the security object comprising security control data and at least one security method; receiving a request for access to the resource; receiving security request data; and providing access to the resource in dependence upon the security control data and the security request data, where the resource comprises information, and providing access to the resource further comprises encrypting the information. Embodiments include storing in the security object a user-selected encryption scheme. Embodiments include establishing a secret key and encrypting information from a resource with secret key encryption. Establishing a secret key is accomplished out of band or with public key encryption.

### BACKGROUND OF THE INVENTION

1. Field of the Invention

The present invention relates to data processing methods, apparatus, systems, and computer program products therefore, and more particularly to methods, apparatus, systems, and computer program products in support of securing valid authentication, authorization, and privacy for access to computer resources and other items.

2. Description of Related Art

It is common to use passwords to control access to resources, including everything from documents, to bank accounts, burglar alarms, automobiles, home security systems, personal video recorders, and so on. Passwords often consist of text strings that a user must provide to a security system in order to obtain access to a secured resource. A password provided by a user typically is checked against a stored password to determine a match. If the entered password and the stored password match, access is granted to the resource.

Mechanisms for managing passwords typically are programmed into the software applications with which the passwords are associated. That is, a program external to the password is used to authenticate the password, check to see whether the password is about to expire, and determine whether and what level of access is to be granted. Systems securing resources therefore typically have password management operations coded into them to process and authenticate a specific type of password content. Users have no control over how passwords are defined or used in typical systems securing resources. Moreover, changing the way in which a password is used typically requires changing program code in a system securing resources.

In addition, such systems generally are capable of accepting and administering security with respect to only one type of password. If passwords are viewed as one type of security control data, then such systems can be said to function with only one kind of security control data. There is no way in such systems for anyone, especially not a user, to change from a password to some other kind of security control data without substantial redesign and recoding. There is no way in such system for a user or anyone else to determine to use more than one kind of security control data without substantial redesign and recoding.

In addition to password security for authentication and authorization, security systems often also provide privacy, generally in the form of encrypted communications of computer resources. Such encryption is usually accomplished with encryption keys and ciphers of the system itself, with the users having little or no choice regarding such matters. It would be beneficial to have improved ways of choosing and using security control data, as well as encryption keys and ciphers, to provide or administer secured resources through computer systems.

### SUMMARY OF THE INVENTION

The present invention provides methods and means for controlling access to a resource, including creating a security object in dependence upon user-selected security control data types, the security object comprising security control data and at least one security method; receiving a request for access to the resource; receiving security request data; and providing access to the resource in dependence upon the security control data and the security request data.

In typical embodiments of the present invention, the resource comprises information, and providing access to the resource further comprises encrypting the information. In such embodiments, creating a security object further comprises storing in the security object a user-selected encryption scheme. In such embodiments, encrypting the information from the resource typically includes establishing a secret key and encrypting the information with secret key encryption. Establishing a secret key includes establishing the secret key out of band or with a public key.

In typical embodiments of the present invention, encrypting the information from a resource includes downloading an encryption scheme from a security object to a client device. In many embodiments, controlling access to a resource includes encrypting security request data. That is, encryption is applied not only to information from the resource itself but also to the security data utilized for controlling access to the resource.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIGS. 1a, 1b, and 1c set forth block diagrams depicting alternative exemplary data processing architectures useful in various embodiments of the present invention.

FIG. 2 sets forth a data flow diagram depicting exemplary methods of controlling access to a resource, including creating a security object and receiving a request for access to a resource, and determining whether to grant access to the resource.

FIG. 2a sets forth a data flow diagram depicting exemplary methods of controlling access to a resource, including methods of establishing a secret key.

FIG. 2b sets forth a data flow diagram depicting exemplary methods of controlling access to a resource, including a method of establishing a secret key with a public key.

FIG. 3 sets forth a data flow diagram depicting an exemplary method of creating a security object.

FIG. 4 sets forth a class relations diagram including a security class and a security control class.

FIG. 5 sets forth a data flow diagram depicting exemplary methods of receiving requests for access to resources.

### DETAILED DESCRIPTION OF EXEMPLARY EMBODIMENTS

### Introduction

The present invention is described to a large extent in this specification in terms of methods for securing valid authentication and authorization for access to computer resources and other items. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product and stored on a diskette or other recording medium for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

In this specification, the terms “field,” “data element,” and “attribute,” unless the context indicates otherwise, generally are used as synonyms, referring to individual elements of digital data. Aggregates of data elements are referred to as “records” or “data structures.” Aggregates of records are referred to as “tables” or “files.” Aggregates of files or tables are referred to as “databases.” Complex data structures that include member methods, functions, or software routines as well as data elements are referred to as “classes.” Instances of classes are referred to as “objects” or “class objects.”

“AES” refers to the Advanced Encryption Standard, a National Institute of Standards and Technology standardization of the ‘Rijndael’ encryption algorithm developed by and named after two Belgian cryptographers, Dr. Joan Daemen of Proton Works International and Dr. Vincent Rijmen of the Electrical Engineering Department of Katholieke Universiteit Leuven. AES, a standardization of Rijndael, is a Federal Information Processing Standard. Rijndael provides for a variety of key sizes, 128, 160, 192, 224, and 256 bits. AES mandates a choice of key size from 128, 192, and 256 bits.

“Browser” means a web browser, a communications application for locating and displaying web pages. Browsers typically comprise a markup language interpreter, web page display routines, and an HTTP communications client. Typical browsers today can display text, graphics, audio and video. Browsers are operative in web-enabled devices, including wireless web-enabled devices. Browsers in wireless web-enabled devices often are downsized browsers called “microbrowsers.” Microbrowsers in wireless web-enabled devices often support markup languages other than HTML, including for example, WML, the Wireless Markup Language.

“Cipher” refers to an encryption scheme, including methods of encrypting and decrypting data. That is, the term ‘cipher’ as used in this disclosure, includes both encryption algorithms and decryption algorithms, both of which are also sometimes referred to as cryptographic functions. With reference to an encryption scheme, ‘cipher’ refers to an encryption algorithm and a decryption algorithm designed to work inversely with one another.

“Ciphertext” refers to encrypted data. “Plain text” refers to unencrypted data. The terms ‘ciphertext’ and ‘plain text’ are used to describe the encrypted quality of data, and they are used in referring to all data, not just data encoded to represent text, but binary, numeric, and control data as well.

“CORBA” means the Common Object Request Broker Architecture, a standard for remote procedure invocation first published by the Object Management Group (“OMG”) in 1991. CORBA can be considered a kind of object-oriented way of making “RPCs” or remote procedure calls, although CORBA supports many features that do not exist in RPC as such. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages such as C++ and Java look like invocations of local member methods in local objects. Whenever a client program, such as, for example, a C++ program, acquires an object reference, decoded from a stringified object reference, from a Naming Service, or as a result from another method invocation, an ORB creates a stub object. Since a stub object cannot exist without an object reference, and an object reference rarely exists outside a stub object, these two terms are often used synonymously. For the server side, a skeleton is generated by the IDL compiler. A developer derives from that skeleton and adds implementation; an object instance of such an implementation class is called a ‘servant.’ The generated skeleton receives requests from the ORB, unmarshalls communicated parameters and other data, and performs upcalls into the developer-provided code. This way, the object implementation also looks like a ‘normal’ class.

“CGI” means “Common Gateway Interface,” a standard technology for data communications of resources between web servers and web clients. More specifically, CGI provides a standard interface between servers and server-side ‘gateway’ programs which administer actual reads and writes of data to and from file systems and databases. The CGI interface typically sends data to gateway programs through environment variables or as data to be read by the gateway programs through their standard inputs. Gateway programs typically return data through standard output.

“Client device” refers to any device; any automated computing machinery, capable of requesting access to a resource. Examples of client devices are personal computers, internet-enabled special purpose devices, internet-capable personal digital assistants, wireless handheld devices of all kinds, garage door openers, home security computers, thumbprint locks on briefcases, web-enabled devices generally, and handheld devices including telephones, laptop computers, handheld radios, and others that will occur to those of skill in the art. Various embodiments of client devices are capable of asserting requests for access to resources via wired and/or wireless couplings for data communications. The use as a client device of any instrument capable of a request for access to a resource is well within the present invention.

A “communications application” is any data communications software capable of operating couplings for data communications, including email clients, browsers, special purpose data communications systems, as well as any client application capable of accepting data downloads (downloads of security objects or resources, for example) via hardwired communications channels such as, for example, a Universal Serial Bus or ‘USB,’ downloads through wired or wireless networks, and downloads through other means as will occur to those of skill in the art. In typical embodiments of the present invention, communications applications run on client devices.

“DCOM” means ‘Distributed Component Object Model,’ an extension of Microsoft's Component Object Model (“COM”) to support objects distributed across networks. DCOM is part of certain Microsoft operating systems, including Windows NT, and is available for other operating systems. DCOM serves the same purpose as IBM's DSOM protocol, which is a popular implementation of CORBA. Unlike CORBA, which runs on many operating systems, DCOM is currently implemented only for Windows.

“DES” refers to the Data Encryption Standard, a secret key cipher published by the National Institute of Standards and Technology for use in commercial and unclassified U.S. government applications. DES was designed by IBM with the participation of the National Security Agency. DES uses a 56-bit key. DES operates more efficiently when implemented in hardware rather than software.

“ECC” refers to elliptic curve cryptography, a public key cipher that provides public key encryption. ECC at the time of this writing is believed to be more secure than RSA with smaller keys.

“HTML” stands for ‘HyperText Markup Language,’ a standard markup language for displaying web pages on browsers.

“HTTP” stands for ‘HyperText Transport Protocol,’ the standard data communications protocol of the World Wide Web.

“IDEA” refers to the International Data Encryption Algorithm, developed by Zuejia Lai and James Massey of ETH Zuria. IDEA is designed to be efficient to compute in software. IDEA uses a 128-bit key.

A “key” is a quantity used with cryptographic algorithms to encrypt or decrypt data. A “secret key” is a single key used for both encryption and description in secret key cryptography. That is, in secret key cryptography, decryption is the reverse of encryption and uses the same key as encryption. “Secret key cryptography” is sometimes referred to as ‘conventional cryptography’ or ‘symmetric cryptography.’ In this disclosure, however, the term “secret key cryptography” is used generally, as an aid to clarity of explanation. In secret key cryptography, a single secret key is shared by users or processes concerned with gaining access to information from a resource and also by security systems concerned with controlling or providing secure access to a resource. Examples of secret key ciphers include DES, IDEA, and AES.

“Public key cryptography” is cryptography using two keys, one for encryption and one for decryption. Unlike secret key cryptography, keys are not shared. Instead, users or processes concerned with gaining access to a resource and the systems, and in this disclosure, security objects, concerned with providing or controlling access to resources, each have two keys, a public key that can be made available to the whole world is typically used to encrypt plain text, and a private key never revealed is typically used to decrypt ciphertext. In public key cryptography, encryption and decryption utilize two mathematical functions that are inverses of one another. Examples of public key ciphers include RSA and ECC.

In this disclosure, a private key is called a ‘private key,’ not a ‘secret key.’ Some people use the term ‘secret key’ to refer to the private key in public key cryptography, or the term ‘private key’ to refer to the secret key in secret key cryptography. In this disclosure, however, the term ‘secret key’ refers only to a single, shared key used for secret key cryptography, and the term ‘private key’ refers only to a private key used in public key cryptography.

A “hyperlink,” also referred to as “link” or “web link,” is a reference to a resource name or network address which when invoked allows the named resource or network address to be accessed. More particularly in terms of the present invention, invoking a hyperlink implements a request for access to a resource. Often a hyperlink identifies a network address at which is stored a resource such as a web page or other document. As used here, “hyperlink” is a broader term than “HTML anchor element.” Hyperlinks include links effected through anchors as well as URIs invoked through ‘back’ buttons on browsers, which do not involve anchors. Hyperlinks include URIs typed into address fields on browsers and invoked by a ‘Go’ button, also not involving anchors. In addition, although there is a natural tendency to think of hyperlinks as retrieving web pages, their use is broader than that. In fact, hyperlinks access “resources” generally available through hyperlinks including not only web pages but many other kinds of data and server-side script output, servlet output, CGI output, and so on.

“LAN” means local area network.

“Network” is used in this specification to mean any networked coupling for data communications among computers or computer systems. Examples of networks useful with the invention include intranets, extranets, internets, local area networks, wide area networks, and other network arrangements as will occur to those of skill in the art.

An “ORB” is a CORBA Object Request Broker.

“Out-of-band” means that an action is effected or carried out by some mechanism separate from automated electrical or optical transmission of computer data. An out-of-band mechanism for key distribution, for example, is something other than automated communications of encrypted keys across a network. Examples of out-of-band key distribution include a person who created a security object with a secret key sharing the secret key by telephoning another user, by sending a written note with the key, or by handing over a floppy disk or a CD with the secret key on it.

A “plug-in” is a hardware or software module that adds a specific feature or service to a larger system. For example, there are a number of plug-ins for the popular browsers and email clients such as Netscape Navigator, Microsoft Internet Explorer, and Microsoft Outlook, that enable such data communications clients to display different types of audio or video messages. More particularly, in embodiments using plug-ins, a plug-in is written in the source code of any computer language, such as C, C++, or Java. The plug-in is then installed in a communications application such as a browser. The plug-in, when invoked, accesses a user interface through the browser to install its own user controls such as GUI buttons, toolbars, pull down menus, and pull down menu entries.

“Resource” means any information or physical item access to which is controlled by security objects of the present invention. Resources often comprise information in a form capable of being identified by a URI or URL. In fact, the ‘R’ in ‘URI’ is ‘Resource.’ The most common kind of resource is a file, but resources include dynamically-generated query results, the output of CGI scripts, dynamic server pages, documents available in several languages, as well as physical objects such as garage doors, briefcases, and so on. It may sometimes be useful to think of a resource as similar to a file, but more general in nature. Files as resources include web pages, graphic image files, video clip files, audio clip files, and so on. As a practical matter, most HTTP resources are currently either files or server-side script output. Server side script output includes output from CGI programs, Java servlets, Active Server Pages, Java Server Pages, and so on.

“RMI,” or “Java RMI,” means ‘Remote Method Invocation,’ referring to a set of protocols that enable Java objects to communicate remotely with other Java objects. RMI's structure and operation is somewhat like CORBA's, with stubs and skeletons, and references to remotely located objects. In comparison with other remote invocations protocols such as CORBA and DCOM, however, RMI is relatively simple. RMI, however, works only with Java objects, while CORBA and DCOM are designed to support objects created in any language.

“RSA” is a public key encryption algorithm, or, in the terminology of this disclosure, a public key cipher or cryptography function. RSA is named for its inventors, Rivest, Shamir, and Adleman. RSA can operate with a variety of key sizes, although a common key length used with RSA is 512 bits. RSA is much slower than popular secret key ciphers like DES or IDEA. RSA therefore is not much used for encrypting long messages. RSA is more often used to encrypt a secret key, that is, a short message, and then secret key cryptography is used to encrypt a long message.

“Server” in this specification refers to a computer or device comprising automated computing machinery on a network that manages resources and requests for access to resources. A “security server” can be any server that manages access to resources by use of security objects according to the present invention. A “web server,” or “HTTP server,” in particular is a server that communicates with browsers by means of HTTP in order to manage and make available to networked computers documents in markup languages like HTML, digital objects, and other resources.

A “Servlet,” like an applet, is a program designed to be run from another program rather than directly from an operating system. “Servlets” in particular are designed to be run on servers from a conventional Java interface for servlets. Servlets are modules that extend request/response oriented servers, such as Java-enabled web servers. Java servlets are an alternative to CGI programs. The biggest difference between the two is that a Java servlet is persistent. Once a servlet is started, it stays in memory and can fulfill multiple requests. In contrast, a CGI program disappears after it has executed once, fulfilling only a single a request for each load and run. The persistence of Java servlets makes them generally faster than CGI because no time is spent on loading servlets for invocations after a first one.

A “URI” or “Universal Resource Identifier” is an identifier of a named object in any namespace accessible through a network. URIs is functional for any access scheme, including for example, the File Transfer Protocol or “FTP,” Gopher, and the web. A URI as used in typical embodiments of the present invention usually includes an internet protocol address, or a domain name that resolves to an internet protocol address, identifying a location where a resource, particularly a web page, a CGI script, or a servlet, is located on a network, usually the Internet. URIs directed to particular resources, such as particular HTML files or servlets, typically include a path name or file name locating and identifying a particular resource in a file system coupled through a server to a network. To the extent that a particular resource, such as a CGI file or a servlet, is executable, for example to store or retrieve data, a URI often includes query parameters, or data to be stored, in the form of data encoded into the URI. Such parameters or data to be stored are referred to as ‘URI encoded data.’

“URLs” or “Universal Resource Locators” comprise a kind of subset of URIs, wherein each URL resolves to a network address. That is, URIs and URLs are distinguished in that URIs identifies named objects in namespaces, where the names may or may not resolve to addresses, while URLs do resolve to addresses. Although standards today are written on the basis of URIs, it is still common to such see web-related identifiers, of the kind used to associate web data locations with network addresses for data communications, referred to as “URLs.” This specification refers to such identifiers generally as URIs.

“WAN” means ‘wide area network.’ One example of a WAN is the Internet.

“World Wide Web,” or more simply “the web,” refers to a system of internet protocol (“IP”) servers that support specially formatted documents, documents formatted in markup languages such as HTML, XML (extensible Markup Language), WML (Wireless Markup Language), or HDML (Handheld Device Markup Language). The term “Web” is used in this specification also to refer to any server or connected group or interconnected groups of servers that implement a hyperlinking protocol, such as HTTP or WAP (the ‘Wireless Access Protocol‘), in support of URIs and documents in markup languages, regardless of whether such servers or groups of servers are coupled to the World Wide Web as such.

### DETAILED DESCRIPTION

Embodiments of the present invention provide security objects for improving the administration of controlling access to secured resources. More particularly, security objects according to embodiments of the present invention provide methods and means to secure privacy of data communications on the basis of user-selected encryption schemes.

Security objects according to some embodiments of the present invention provide secret key encryption with secret keys generated when a security object is instantiated and then communicated out of band in a manner similar to a password. In such embodiments, a secret key used like a password is known only to the user who instantiated the security object, usually through use of a foundry, and optionally to one or more others to whom the instantiating user may distribute the secret key. The other to whom a secret key may be distributed includes other users who may be granted access to a resource secured by a particular security object having an encryption scheme that uses the secret key.

Despite its superficial similarity to a password, a secret key so used in embodiments of the present invention still functions independently of other security control data types, regular passwords, userIDs, retinal scans, thumbprints, and so on. This is an advantage because, particularly in the case of secret keys established with public keys, even when security request data is communicated out of band, secret keys need not be.

Users instantiating security objects according to the present invention are empowered to make their own selections of encryption schemes. In this way, for example, users can for the first time conveniently choose, for example, a faster encryption algorithm using a shorter key length for use with less sensitive information in a resource. Or a user can choose a slower but more secure encryption algorithm with a longer key for more sensitive information in another resource.

A resource can be secured with different encryption schemes across different recipients, for example, the same resource being secured by several security objects each having a different encryption scheme and each authorizing access for a different recipient, all arranged with a few keystrokes in a foundry. That is, a user instantiating security objects to secure resources can use a different encryption scheme for each recipient of confidential information from a resource, by instantiating a separate security object for each such recipient, each such security object covering the same resource, each such security object having its own encryption scheme.

According to many embodiments of the present invention, neither the recipient of information from a resource secured by a security object, nor any security server, nor any resource server, nor any ISP nor system administrator has any knowledge of the encryption scheme, all of which is provided by a controlling security object. The encryption scheme in use in a particular security object is known only to the user who operated the foundry that created the security object. Moreover, to the extent that encryption is carried out with a secret key established with a public key, no human being has any knowledge whatsoever of the encryption key.

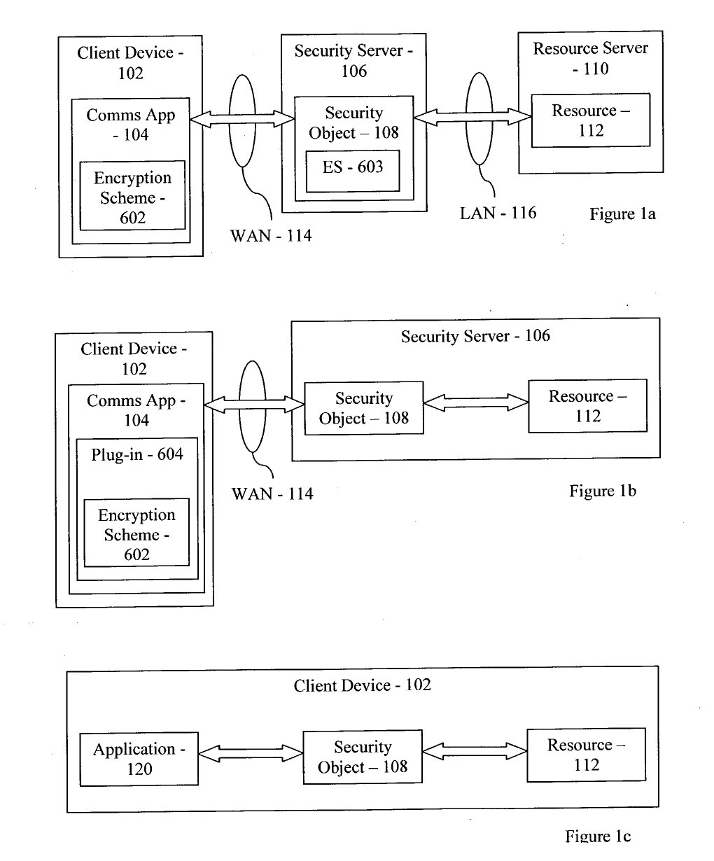

FIGS. 1a, 1b, and 1c set forth block diagrams depicting alternative exemplary data processing architectures useful in various embodiments of the present invention. As illustrated in FIG. 1a, some embodiments of the present invention deploy security objects (108) in security servers (106) coupled for data communications through LANs (116) to resource servers (110) upon which resources (112) are stored. Such embodiments typically are coupled for data communications to client devices (102) through networks such as WANs (114) or LANs (116). Data communications between client devices and security servers in such architectures are typically administered by communications applications (104), including, for example, browsers. WANs include internets and in particular the World Wide Web. Client devices (102) are defined in detail above and include any automated computing machinery capable of accepting user inputs through a user interface and carrying out data communications with a security server. A “security server” is any server that manages access to resources by use of security objects according to the present invention.

In the exemplary architecture of Figure la, the client device (102) includes an encryption scheme (602). The encryption scheme (602) is user selected and includes one or more ciphers and one or more keys. The encryption scheme (602) is implemented so that it will work in cooperation with a similar encryption scheme (603) in a security object (108). An encryption scheme (602) in a client device (102) and an encryption scheme (603) in a security object (108) advantageously function in cooperation. In the case of secret key cryptography, they both use the same secret key and therefore also the same ciphers. In private key cryptography, both sides use the same cipher set inversely. That is, in private key cryptography, a security object encrypts information with a client device's public key, which information is then decrypted with the client device's private key in the client device by a decryption algorithm from the same cipher set.

As illustrated in FIG. 1b, some embodiments of the present invention deploy security objects (108) in security servers (106) upon which are stored secured resources (112). The architecture of FIG. 1b illustrates that resources can be stored on the same server that secures access to the resources. In all this discussion, the term ‘security server’ refers to a server that manages access to resources by use of security objects according to the present invention. There is no limitation that a ‘security server’ as the term is used in this disclosure must provide other security services, or indeed that a security server must provide any security services whatsoever, other than managing access to resources through security objects. FIGS. 1a and 1b show security objects deployed in or upon security servers, but having security objects deployed upon it is not a requirement for a server to be considered a security server within the usage of this disclosure. Security objects may be deployed anywhere on a network or on client devices. If a server manages access to resources by use of security objects, regardless where the security objects are located, then that server is considered a ‘security server’ in the terminology of this disclosure. Some ‘security servers’ of the present invention, as described in more detail below, are ordinary web servers modified somewhat to support lookups in access control tables. Many ‘security servers’ of the present invention, however, are ordinary unmodified web servers or Java web servers, designated as ‘security servers’ only because they manage access to resources by use of security objects, security objects which may or may not be installed upon those same servers.

In the example of FIG. 1b, the encryption scheme (602) in the client device (102) is deployed to the client device as a plug-in (604). Such a plug-in (604) can be deployed as an electronic card with firmware, which can be advantageous for ciphers like DES that tend to function more efficiently when implemented in hardware. A plug-in (604) can be deployed as a networked HTTP or SHTTP download from a server (106) to a communications application (104) implemented for example as a browser. Such software plug-ins can be, for example, Java plug-ins for Java-enabled browsers. Other ways of implementing plug-ins for encryption schemes on client devices will occur to those of skill in the art, and all such ways are well within the scope of the present invention.

As shown in FIG. 1c, some embodiments deploy security objects (108) in client devices (102) which themselves also contain both the applications software (120) concerned with accessing the resources and also the resources (112) themselves. This architecture includes devices in which a security object may be created on a more powerful machine and then downloaded to a less powerful machine. The less powerful machine then often is associated one-to-one with a single resource, or is used to secure a relatively small number of resources. For example, a security object implementing an encryption scheme can be used to encrypt data on a personal computer hard disk. Another example of this kind of embodiment includes a garage door opener in which a security application program (120) is implemented as an assembly language program on a tiny microprocessor or microcontroller and the secured resource is a motor that operates a garage door. Another example is a briefcase fitted with a microprocessor or microcontroller, a fingerprint reader, and a USB port through which is downloaded a security object that controls access to a resource, an electromechanical lock on the briefcase.

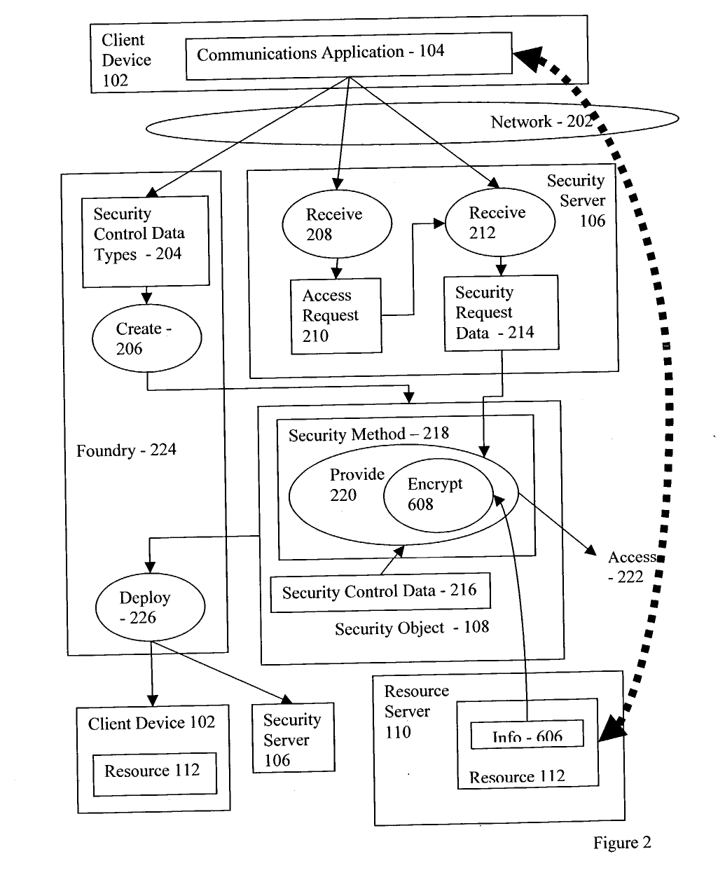

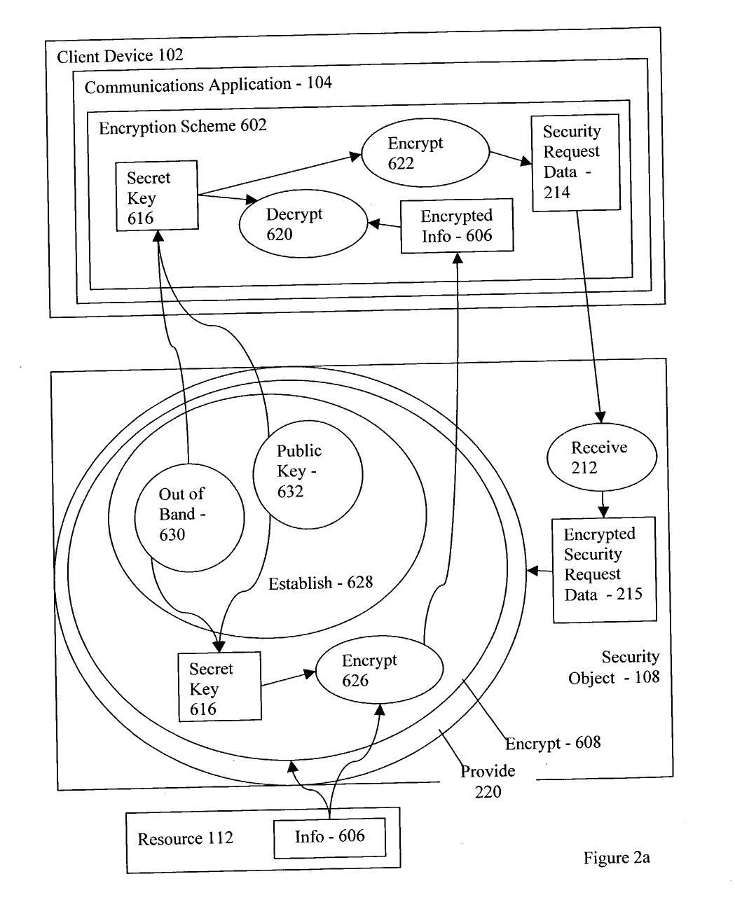

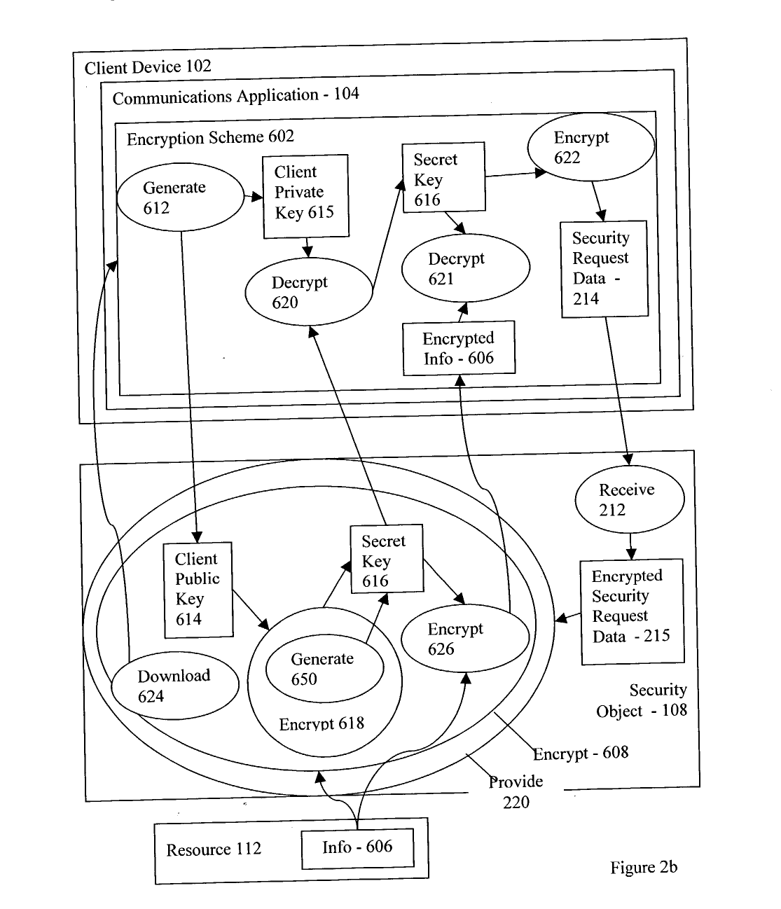

FIG. 2 sets forth a data flow diagram depicting an exemplary method of controlling access to a resource (112). The method of FIG. 2 includes creating (206) a security object (108) in dependence upon user-selected security control data types (204), the security object comprising security control data (216). In this disclosure, the application programs that administer the creation of security objects are called ‘foundries.’ In typical embodiments according to FIG. 2, a foundry (224) prompts a user through a user interface displayed on a client device (102) to select one or more security control data types through, for example, use of a menu similar to this one:

Please select a security control data type:

1. User Logon ID

2. Password

3. Fingerprint

4. Voice Recognition

5. Retinal Scan

Your selection (1-5): ______

The foundry (224) creates (206) the security object (108) in dependence upon the user's selections of security control data types in the sense that the foundry aggregates into, or associates by reference, the security object security control data types according to the user's selection. If, for example, the user selects menu item 1 for a user logon ID, the foundry causes a security control data type to be included in the security object for administration of a user logon ID. If the user selects menu item 2 for a password, the foundry causes a security control data type to be included in the security object for administration of a password. If the user selects menu item 3 for a fingerprint, the foundry causes a security control data type to be included in the security object for administration of fingerprints. And so on for voice recognition technology, retinal scans, and any other kind of security control data amenable to administration by electronic digital computers.

In typical embodiments of the present invention, as shown in FIG. 2, a security object (108) includes at least one security method (218). In this disclosure, ‘security method’ means an object oriented member method. The security method typically is a software routine called for validating or determining whether to grant access to a resource and what level of authorization to grant. As discussed in more detail below, the security method can have various names depending on how the security object is implemented, ‘main( )’ for security objects to be invoked with Java commands, ‘security( )’ for servlets, and so on. These exemplary names are for clarity of explanation only, not for limitation. In many forms of security object, the name chosen for the security method is of no concern whatsoever.

Embodiments according to FIG. 2 include receiving (208) a request (210) for access to the resource and receiving a request for access to a resource can be implemented as a call to a security method in a security object. A security object implemented in Java, for example, can have a main( ) method called by invocation of the security object itself, as in calling ‘java MySecurityObject,’ resulting in a call to MySecurityObject.main( ). This call to main( ) is in many embodiments itself receipt of a request for access to the resource secured by use of the security object.

The method of FIG. 2 includes receiving (212) security request data (214).

Continuing with the example of a security object called ‘MySecurityObject,’ the security object's member security method can prompt the user, or cause the user to be prompted, for security request data in dependence upon the security control data types in use in the security object. That is, if the security object contains security control data of type ‘User Logon ID,’ then the security method causes the user to be prompted to enter security request data, expecting the security request data received to be a user logon ID. If the security object contains security control data of type ‘Password,’ then the security method causes the user to be prompted to enter security request data, expecting the security request data received to be a password. If the security object contains security control data of type ‘Fingerprint,’ then the security method causes the user to be prompted to enter security request data, expecting the security request data received to be a digital representation of a fingerprint. The security method in such embodiments typically does not include in its prompt to the user any identification of the security control data type expected. This is, after all, a security system. If the user does not know that the user must provide in response to a first prompt a password and in response to a second prompt a thumbprint in order to gain access to a particular resource, then the user probably ought not gain access to the resource.

As described in more detail below, security objects typically associate by reference one or more security control objects having member methods that carry out actual security request data validation. Calls from a security object's security method to member methods in security control objects are what are meant by saying that a security method “causes” a user to be prompted for security request data.

The method of FIG. 2 includes providing (220) access (222) to the resource in dependence upon the security control data (216) and the security request data (214). More particularly, providing access means determining whether to grant access and what kind of access is to be granted. Generally in this disclosure, whether to grant access to a particular user is referred to as ‘authentication,’ and the kind of access granted is referred to as ‘authorization level.’ Determining whether to grant access typically includes determining whether security access data provided by a user in connection with a request for access to a resource matches corresponding security control data. That is, in the example of a password, determining whether to grant access includes determining whether a password provided as security access data matches a password stored in aggregation with a security object as security control data. In the example of a thumbprint, determining whether to grant access includes determining whether a thumbprint provided as security access data matches a thumbprint stored in aggregation with a security object as security control data. And so on. Authorization levels include authorization to read a resource, authorization to write to a resource (which typically includes ‘edit’ authority and ‘delete’ authority), and authorization to execute a resource (for which one ordinarily needs an executable resource).

In the method according to FIG. 2, the resource (112) comprises information (606), and providing (220) access (222) to the resource further comprises encrypting (608) the information (606). The information comprised within the resource can be anything that can be represented as computer data, text, numeric, files, streams, other data structures, computer programs, audio files, MP3 clips, video, other multimedia files, and so on, as will occur to those of skill in the art.

Encrypting (608) the information (606) generally include calling a member method in a class object that carries out a kind of encryption according to a user-selected encryption scheme that includes a cipher such as DES, AES, RSA, and so on, or a non-standard cipher known only to a developer who develops a security object and the user who instantiates it. There is no limitation in the current invention that a cipher used in an encryption scheme of the present invention must be a standard, known cipher. On the contrary, the fact that an encryption scheme in a client device and an encryption scheme in a security object according to embodiments of the present invention are generally implemented so that each uses the same encryption scheme, then the encryption scheme can be any encryption scheme, without regard to what is most common, most popular, or what scheme is generally supported by some intervening security service on an ISP's server. In embodiments of the present invention, the determination of the encryption scheme, although amenable to system administration, nevertheless often is determined at the level of applications and users of applications.

FIG. 2a illustrates a method of controlling access to a resource (112) where providing (220) access to the resource includes encrypting (608) information (606) from the resource. In the method of FIG. 2a, encrypting (608) information (606) from a resource (112) includes establishing (628) a secret key (616) and then encrypting (608) the information (606) with secret key encryption (626). A secret key is used by both sides of a communication for both encryption and decryption, so ‘establishing’ a secret key includes making the secret key available to both sides. A secret key can be generated as a random number by a member method in a security object dedicated to that purpose, or, if a more mnemonic key is desired, a secret key can be prompted for and entered through a user interface by a user using a foundry to create a security object Both of these methods make the secret key available to the security object. The issue remains, however, how to make the secret key available to the other side of the conversation, the client device.

According to the example of FIG. 2a, establishing (628) a secret key (616) can include establishing the secret key out of band (630). Out of band establishing can be any method of making the key available to a client device other than automated electrical or optical transmission of computer data. Out of band establishing of a secret key includes oral communications of the key. Out of band establishing of a secret key includes a client device's prompting for a recipient to type in the key, where the recipient learned the key in a phone call from the user who established the key in a security object through a foundry. Out of band establishing of a secret key includes emailing the key from a user who established the secret key in a security object through a foundry to another user who wishes to access a resource as a recipient of information. Out of band establishing of a secret key includes one user's sending to another user a written note with the key, or handing over a floppy disk or a CD with the secret key on it.

More particularly, establishing a secret key includes sharing the secret key with both sides of a communication of information from a resource. That means in many embodiments that the key is possessed by both the client side and the server side, or by a client side communications application and by a security object on the server side. An example of a client side communications application is a browser with a plug-in containing a cipher that will work with the secret key. Establishing a secret key out of band can include a creator of a security object typing in a secret key in response to prompts from a foundry interface, then telephoning it or emailing it to another user. Establishing a secret key out of band can include a creator of a security object typing in a secret key to a security object through a foundry interface, then walking around the office to a personal computer having a browser and entering the secret key through a browser data entry prompt.

In a further embodiment of the invention, illustrated also with reference to FIG. 2a, the illustrated method of controlling access to a resource includes encrypting (622) security request data (214). In the example of FIG. 2a, the security request data is encrypted with a secret key (616) established out-of-band (630) or by use of a public key (632). In the example of FIG. 2a, when security request data is received (212) in a security object (108) it is in encrypted form (215). In the example of FIG. 2a, the security request data is encrypted with a secret key (616), but readers of skill in the art will realize that the security request data also can be encrypted with a public key, in particular with a public key of a security object for which the security request data is intended, so that the security request data can be unencrypted in the security request object by use of the complementary private key of the security request object. Either way, encrypting security request data has advantages in securely controlling access to information in resources.

Such encryption of security request data is particularly an advantage with respect to security request data utilized for authentication and authorization decisions so that data such as passwords, userIDs, retinal scans, thumbprints and the like are not necessarily transmitted in plain text over unsecured networks. Transmitting security request data in plain text over unsecured networks can occur, for example, in applications where a communications application on a client device is implemented as a browser that invokes a security object with a URI in a hyperlink over ordinary HTTP, no SSL, no SHTTP, so that the only security provided is through the security object itself. Recall that in the terminology of this disclosure, unencrypted data is considered plain text even when it is numeric or purely digital, as are digital representations of retinal scans and thumbprints. This is a relevant attribute of such data, because the fact that it is not text as such does not reduce whatever security effect might be associated with its transmission unencrypted.

According to the example of FIG. 2a, establishing (628) a secret key (616) can include establishing the secret key with a public key (632). FIG. 2b illustrates a method of establishing a secret key with a public key. More particularly, the method of FIG. 2b includes generating (612) a client device's public key (614) in a communications application (104) in a client device (102). Generating (612) the public key (614) is carried out by a call to a member method implementing an algorithm for that purpose, an algorithm that will vary according to the encryption scheme (602), that is, being different for a public key for RSA than a public key for ECC. As a practical matter, the communications application through its encryption scheme will ordinarily generate a client-side private key (615) also. The communications application (104) makes the client device's public key (614) available for use in a security object (108) by, for example, transmitting it in an HTTP request or post message. The public key (614) can be transmitted unencrypted over unsecured networks with no security effect whatsoever.

The method of FIG. 2b includes using the client device's public key (614) for public key encryption (618) of a secret key (616). The secret key (616), so encrypted with the client's public key, can then be transmitted back to the client device (102) across unsecured networks, or otherwise, as will occur to those of skill in the art. Then in the client device, the secret key (616) encrypted with the client device's public key, can be decrypted (620) with the client device's private key (615). At this point in processing, the secret key (616) is established on both sides of communications, on the side of the security object and on the side of the client device. Now the security object, according to the method of FIG. 2b, secret key encrypts (626) information (606) from a resource (112) using the secret key (616) and transmits the information so encrypted across an unsecured network to the client device. The client device, according to the method of FIG. 2b, decrypts (621) the encrypted information (606) with the secret key (616).

Consider an example, illustrated also in FIG. 2b, where the process for public key encrypting (618) a secret key (616) includes generating (650) the secret key, for example, with a random number generator. That is, the secret key is generated without prompting a user to enter a value that might have some mnemonic value. In such an example, the secret key can be generated under automation, encrypted with a client's public key, transmitted across a network to the client, decrypted with a client's private key, used to encrypt information from a resource, decrypt the information on the client side, and completely discarded after that use, all without any human being ever knowing its value. This example illustrates an advantage of establishing a secret key by use of a public key, that is, the secret key actually used to encrypt information from a resource typically is not communicated out of band. An advantage of establishing a secret key out of band is that it is computationally simpler.

In the method of FIG. 2b, encrypting (618) the information (606) from the resource (112) includes downloading (624) an encryption scheme (602) from a security object (108) to a client device (102). In this example, the encryption scheme is an object that includes ciphers, encryption algorithms, decryption algorithms, a public key generation function, and so on, all the member data and member methods needed to implement an encryption scheme in a client device. Downloading (624) the encryption scheme (602) can be implemented by, for example, instantiating an encryption scheme as a stringified Java object, downloading the Java object, and installing the Java object in a client-side communications application that is a Java enabled browser. Downloading (624) the encryption scheme (602) can be implemented, for another example, by implementing the encryption scheme as a Java applet, downloading the Java applet as a plug-in for a client device, and installing the Java object in a client-side communications application that is a Java enabled browser. It is also within the scope of the present invention to download an encryption scheme out of band, for example, by mailing it on a diskette or a CD and installing it from a floppy drive or an optical drive. Other ways of downloading encryption schemes to client devices will occur to those of skill in the art, and all such ways are well within the scope of the present invention.

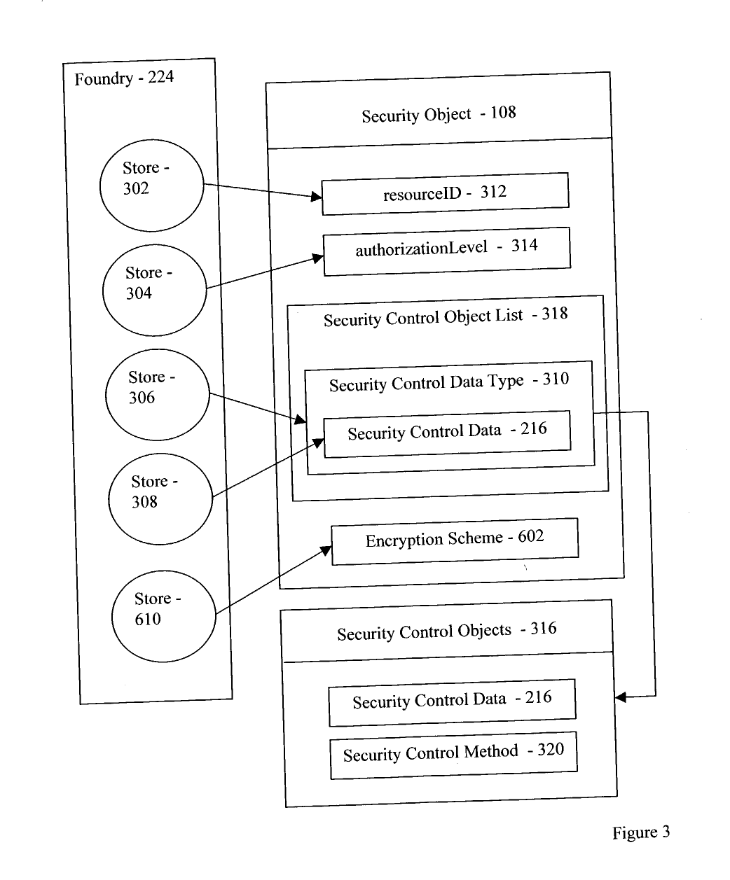

FIG. 3 sets forth a data flow diagram depicting an exemplary method of creating a security object. That is, FIG. 3 depicts in more detail what it means to create a security object through a foundry according to embodiments of the present invention. In the method of FIG. 3, creating a security object includes storing (302) in the security object (108) a resource identification (312) for the resource. Storing a resource identification can be carried out, for example, by a foundry's prompting a user to enter a filename, pathname, URL, URI, or any useful means, as will occur to those of skill in the art, for identifying a resource to be secured by the security object. In this example, the foundry then stores (302) the identification of the resource in a member field called ‘resourceID’ (312) in the security object itself.

In the method of FIG. 3 creating a security object includes storing (304) in the security object (108) an authorization level (314) of access for the resource. Storing an authorization level can be carried out by programming a foundry to prompt a user to enter an authorization level, ‘read,’ ‘write,’ or ‘execute,’ for example, and then storing (304) the authorization level in a member field named, for example, ‘authorizationLevel’ (314) in the security object itself.

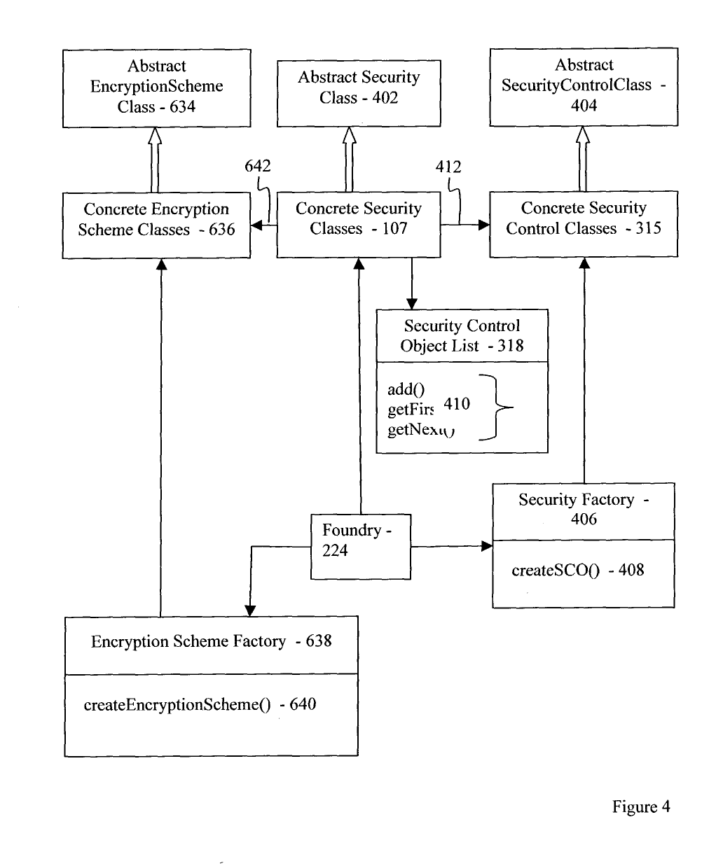

In the method of FIG. 3, creating a security object includes storing (306) in the security object (108) user-selected security control data types (310). More particularly, in the method of FIG. 3, security control data types (310) are stored, for example, as references to security control objects (316). Security control data types (310), according to typical embodiments of the present invention, are security control classes (404 on FIG. 4) from which security control objects are instantiated. Storing (306) user-selected security control data types comprises storing references to security control objects (316) in a security control object list (318) in a security object (108), including instantiating a security control object (316) of a security control class in dependence upon security control data type. That is, when a user selects from a foundry display a security control data type representing a password, then the foundry causes to be instantiated from a password security control class a password security control object and stores in the security control object list (318) a reference to the password security control object. Similarly, if a user selects the security control data type for a fingerprint, then the foundry causes to be instantiated from a fingerprint security control class a fingerprint security control object and stores in the security control object list (318) a reference to the fingerprint security control object. In many embodiments according to the present invention, instantiating a particular user-selected security control object is carried out by use of a factory method as described in more detail below in this disclosure.

The security control object list (318) itself is typically implemented as a container object from a standard library in, for example, C++ or Java. That is, the security control object list (318) is typically a class object aggregated by reference to the security object (108). Security control object lists, and other such aggregations, are often referred to in this disclosure as ‘lists,’ but such references are for explanation, not for limitation. Such aggregation can in fact be implemented as sets of references to objects, arrays, linked lists, and other forms of aggregation as will occur to those of skill in the art.

According to the method of FIG. 3, creating a security object includes storing (308) in the security object security control data (216) for each user-selected security control data type (310). Instantiating a security control object (316) calls a constructor for the security control object. In some embodiments, it is the constructor that prompts for security control data of the type associated with the security control object. That is, if the security control data object is a password security control object, its constructor prompts for a password to be stored (308) as security control data (216). Similarly, if the security control data object is a thumbprint security control object, its constructor prompts for a thumbprint to be stored (308) as security control data (216). And so on.

In the method according to FIG. 3, creating a security object includes storing (610) in the security object (108) a user-selected encryption scheme (602). In typical embodiments, storing (610) a user-selected encryption scheme (602) comprises instantiating an encryption scheme object that implements a user-selected encryption scheme and storing in a security object (108) a reference (602) to the instantiated encryption scheme object. In typical embodiments according to the present invention, an encryption scheme is implemented as an encryption scheme object comprising ciphers and keys. Encryption schemes comprise secret key encryption schemes, including secret key ciphers and secret keys, and encryption schemes comprise public key encryption schemes, including public key ciphers, public keys, and private keys. Because public keys are often used to establish secret keys, encryption scheme objects that implement secret key encryption schemes often include also a public key cipher and storage for public and private keys.

More particularly for example, in the method according to FIG. 3, when a user selects from a foundry display an encryption scheme for secret key encryption with DES, the foundry instantiates a DES encryption scheme object of a concrete DES encryption scheme class and stores (610) in the security object a reference (602) to that DES encryption scheme object. Similarly, if a user selects from a display in a foundry user interface an encryption scheme for public key encryption with RSA, the foundry instantiates an RSA encryption scheme object of a concrete RSA encryption scheme class and stores (6 10) in the security object a reference (602) to that RSA encryption scheme object. In many embodiments according to the present invention, foundries instantiate encryption scheme objects that implement particular user-selected encryption schemes by use of a factory method as described in more detail below in this disclosure.

In architectures similar to those illustrated in FIGS. 1a and 1b in which a client device (102) is located remotely across a network (114) from a security server (106) upon which security control data is to be stored (308), the security control data advantageously is communicated across the network from the client device to the security server in encrypted form. One example of such encrypted communications is network messaging by use of ‘SSL,’ that is, communications connections through a ‘Secure Sockets Layer,’ a known security protocol for use in internet protocol (“IP”) networks, in which encryption of message packets is provided as a standard communications service. In addition to encrypted communications of security control data, at least some elements of security control data, such as, for example, passwords, also are advantageously stored (308) in encrypted form.

Even more particularly, foundries according to the present invention may be implemented and operated in accordance with the following pseudo code.

```
Class Foundry {
    private String selectionText =
        “Please select a security control data type:
          1. Password
          2. Fingerprint
          3. Voice Recognition
        Your selection (1-3):  ”
    private String encryptionSchemeText =
        “Please select an encryption scheme:
          1. DES
          2. IDEA
          3. AES - 128 bit
          4. AES - 256 bit
          5. RSA
          6. ECC
        Your selection (1-6):  ”
    void main( ) {
        // create security object
        SecurityClass SO = new SecurityClass( );
        // identify resource secured by the new security object
        Resource resourceID =
            getResourceID(“Please enter resource ID:  ”);
        // store resource ID in security object
        SO.setResource(resourceID);
        // prompt for authorization level
        char authorizationLevel =
            getAuthorizationLevel(“Please enter authorization
            level:  ”);
        // store authorization level in security object
        SO.setAuthorizationLevel(authorizationLevel);
        // select an encryption scheme
        ES-Type = getUserSelection(encryptionSchemeText);
        EncryptionScheme anEncryptionScheme =
            EncryptionSchemeFactory.createEncryptionScheme(ES-
            Type);
        // store encryption scheme in security object
        SO.setEncrpytionScheme(anEncryptionScheme);
        // get a first ‘SCD-Type,’ Security Control Data Type
        SCD-Type = getUserSelection(selectionText);
        while(SCD-Type != null) {
            // based on SCD-Type, create Security Control Object
            SCO = SCO-Factory.createSCO(SCD-Type);
            // store security control data in the security control object
            SCO.setSecurityControlData( );
            // add new SCO to the list in the Security Object
            SO.add(SCO);
            // get another SCD-Type, as many as user wants
            SCD-Type = getUserSelection(selectionText);
        } // end while( )
    } // end main( )
} // end Foundry
```

With reference to FIGS. 2 and 3, the pseudocode foundry creates (206) a security object (108) by instantiating a security class:

SecurityClass SO=new SecurityClass( ).

The pseudocode foundry then stores (302) a resource identification (312) through:

Resource resourcesID=getResourceID(“Please enter resource ID: ______”);

SO.setResource(resourceID);

The call to SO.setResource( ) is a call to a member method in the security object described in more detail below. The pseudocode foundry stores (304) an authorization level (314) through:

char authorizationLevel=getAuthorizationLevel(“Please enter authorization level: ______”)

SO.setAuthorizationLevel(authorizationLevel);

The call to SO.setAuthoriztionLevel( ) is a call to a member method in the security object described in more detail below.

The pseudocode foundry stores (610) an encryption scheme (602) in a security object (108) by prompting a user of the foundry to select an encryption scheme:

ES-Type=getUserSelection(encryptionSchemeText);

The exemplary text string represented as ‘EncryptionSchemeText’ sets forth only six encryption schemes for the user to choose among, but the number six is for explanation only, not for limitation. Any number or combination of encryption schemes is within the scope of the present invention. The pseudocode foundry proceeds with storing the encryption scheme with a call to a factory method in an encryption scheme factory class:

EncryptionScheme anEncryptionScheme=EncryptionSchemeFactory.createEncryptionScheme(ES-Type);

The call to createEncryuptionScheme( ) instantiates a concrete encryption scheme object and returns a reference to it. The security object ‘SO’ provides a set function, a member method in the security object itself, for associating the new encryption scheme with the security object:

SO.setEncrpytionScheme(anEncryptionScheme);

The pseudocode foundry stores (306) security control data types (310) by repeated calls to SO.add(SCO). SO.add( ) is a member method in the security object that adds security control objects to a list in the security object as described in more detail below.

The pseudocode foundry stores (308) security control data (216) in the security object (108) by repeated calls to SCO.setSecurityControlData( ).

SCO.setSecurityControlData( ) is a member method in a security control object (316) that prompts for and stores a type of security data with which the security control object is associated, fingerprints for fingerprint security control object, passwords for password security control objects, and so on. A separate security control object is created for each security control data type selected or request by the user in response to getUserSelection(selectionText).

Each time the user selects a new security control data type, the foundry creates a new security control object by calling a factory method in a security control object factory. The security control object factory is a class called SCO-Factory, and the factory method is SCO-Factory.createSCO( ). The calls to SCO.setSecurityControlData( ) are polymorphic calls, each of which typically accesses a different security control object although exactly the same line of code is used for each such call. In this elegant solution, the foundry itself never knows or cares which security control data types are implemented or what security control data is stored in security objects it creates.

Readers of skill in the art may notice that the foundry could be made even leaner by allowing security control object constructors to carry out the work of SCO.setSecurityControlData( ). In this example, however, for clarity of explanation of the operation of the foundry, SCO.setSecurityControlData( ) is left at the foundry level so that the effects of foundry operations are more fully exposed by the foundry itself.

The process of creating security control objects can be carried out as illustrated in the following pseudocode factory class:

```
//
// Security Control Object Factory Class
//
// Defines a parameterized factory method for creating security control
objects
//
class SCO-Factory {
    public static SecurityControlClass createSCO(SCD-Type) {
        // establish null reference to new Security Control Object
        SecurityControlClass SecurityControlObject = null;
        switch(SCD-Type) {
            case LOGONID:
                SecurityControlObject = new
                LogonIDSecurityControlClass;
                break;
            case PASSWORD:
                SecurityControlObject = new
                PasswordSecurityControlClass;
                break;
            ... ... ... // Can have many security control data types,
                        // not merely these four
            case FINGERPRINT:
                SecurityControlObject = new
                FingerprintSecurityControlClass;
                break;
            case RETINA:
                SecurityControlObject = new
                RetinaSecurityControlClass;
                break;
        } // end switch( )
        return SecurityControlObject;
    } // end createSCO ( )
} // end class SCO-Factory
```

The factory class for security control objects implements the createSCO( ) method, which is a so-called parameterized factory method. CreateSCO( ) accepts as a parameter the security control data type ‘SCD-Type’ of the security control data to be administered by a security control object. CreateSCO( ) then operates a switch( ) statement in dependence upon SCD-Type to decide exactly which security control class to instantiate depending on which type of security control data is needed—logon IDs, passwords, fingerprints, voice identifications, and so on. Although only four security control data types are illustrated in the factory class (logon IDs, passwords, fingerprints, and retinal scans), in fact the factory can create and return to the calling foundry a security control object for any type of security control data supported by the security system in which it is installed, that is, any type of security control object for which a security control data type or class (404) is defined.

Security control objects can be instantiated from a security control class according to the following pseudocode security control class:

```
//
// abstract SecurityControlClass
//
Abstract Class SecurityControlClass {
    private String SecurityControlData;
    public void setSecurityControlData( ) {
        SecurityControlData =
                prompt( “Please enter security control data:  );
    }
    public boolean validate( ) {
        SecurityAccessData =
            prompt(“Enter Security Access Data:  ”);
        if(SecurityControlData == SecurityAccessData) return true;
        else return false;
    }
}
```

The pseudocode security control class depicts an object oriented ‘interface.’ In Java, such structures are literally known as ‘interfaces’ to be ‘extended’ by concrete classes. In C++, such structures are known as abstract base classes from which concrete subclasses inherit. Either way, the pseudocode security control class establishes a set of public member methods to be used by all security control objects. The pseudocode security control class provides string storage of security control data, which may work just fine for logon IDs and passwords, but will not work for fingerprints and voice recognition. Similarly, setSecurityContolDate( ) and validate( ) will be implemented differently for different types of security control data.

The member fields and member methods of the pseudocode security control class form an interface that is fully expected to be overridden in subclasses from which security control objects are instantiated, although all subclasses are required to implement in some fashion the public member fields and public member methods of the abstract base class, the security control class. Here, beginning with a concrete security control class for logon IDs, are several examples of concrete security control classes from which practical security control objects are instantiated by the factory method SecurityControlClass.createSCO( ).

```
//
// concrete security control class for logon IDs
//
Class LogonIDSecurityControlClass : SecurityControlClass {
    private String SecurityControlData;
    public void setSecurityControlData( ) {
        SecurityControlData =
                prompt( “Please enter security control data:  );
    }
    public boolean validate( ) {
        SecurityAccessData =
            prompt(“Enter Security Access Data:  ”);
        if(SecurityControlData == SecurityAccessData) return true;
        else return false;
    }
}
```

The LogonIDSecurityControlClass appears almost identical to its parent SecurityControlClass, but it is important to remember that LogonIDSecurityControlClass, unlike its abstract parent, defines a class that can actually be instantiated as a security control object for providing access to resources on the basis of entry of a valid logon ID. The following pseudocode security control class for fingerprints illustrates how security control classes differ across security control data types.

```
//
// concrete security control class for fingerprints
//
Class FingerprintSecurityControlClass : SecurityControlClass {
    private File SecurityControlData;
    public void setSecurityControlData( ) {
        SecurityControlData =
                prompt( “Please enter security control data:  );
    }
    public boolean validate( ) {
        FILE SecurityAccessData =
            prompt(“Enter Security Access Data:  ”);
        if((bitwiseCompare(SecurityControlData,
        SecurityAccessData))!=true)
            return true;
        else return false;
    }
}
```

In FingerprintSecurityControlClass, SecurityControlData is in a file rather than a string. Similarly, the prompt( ) function in the validate( ) method expects the user to provide a fingerprint file in response to the prompt for security control data. In addition, the bitwiseCompare( ) method, although not shown, is implemented to open both files, compare them bit by bit, and ultimately deny access to a resource if the comparison fails.

The following pseudocode security control class for a password illustrates how security control classes can utilize encryption schemes for encryption of security request data.

```
//
// concrete security control class for a password
//
Class PasswordSecurityControlClass : SecurityControlClass {
    // storage for password, entered through foundry
    // remember: the security control lpassword here is the
    // security control data for this security control class
    private String SecurityControlPassword;
    public void setSecurityControlData( ) {
        SecurityControlPassword = prompt( “Password:  );
    }
    public boolean validate(anEncryptionScheme) {
        String SecurityRequestPassword =
            prompt(“Password:  ”);
        SecurityRequestPassword =
            anEncryptionScheme.decrypt(SecurityRequestPassword);
        if(SecurityControlPassword == SecurityRequestPassword)
            return true;
        else return false;
    }
}
```

PasswordSecurityControlClass provides storage for security control data entered through a foundry, in this example, a password named SecurityControlPassword. The validate( ) function in PasswordSecurityControlClass takes as a parameter a reference to the encryption scheme in use in a security object with which PasswordSecurityControlClass is associated. Through the prompt( ) call:

String SecurityRequestPassword=prompt(“Password: ______”);

the validates function, as shown in FIG. 2a, receives (212) encrypted security request data (215), in this example, an encrypted password named SecurityRequestPassword. The security request password was encrypted in a communications application using the same encryption scheme as the security object with which PasswordSecurityControlClass is associated. The reference to the encryption scheme object PasswordSecurityControlClass is ‘anEncryptionScheme,’ communicated by the reference parameter in the validate( ) function, validate(anEncryptionScheme). The validate( ) function uses the reference to the encryption scheme to decrypt the password:

SecurityRequestPassword=anEncryptionScheme.decrypt(SecurityRequestPassword).

The validate( ) function compares the now unencrypted security request password with the security control password, and, if they match, returns ‘true,’ otherwise ‘false’:

if(SecurityControlPassword==SecurityRequestPassword) return true;

else return false;

Encryption schemes, or more particularly, encryption scheme objects implementing particular encryption schemes, can be created as illustrated in the following exemplary pseudocode encryption scheme factory class:

```
//
// Encryption Scheme Factory Class
//
// Defines a parameterized factory method
// for creating encryption scheme objects
//
abstract class EncryptionSchemeFactory {
    public static EncryptionScheme createEncryptionScheme(ES-Type) {
        // establish null reference to new encryption scheme object
        EncryptionSchemeClass EncryptionSchemeObject = null;
        switch(ES-Type) {
            case DES:
                EncryptionSchemeObject = new
                DESEncryptionSchemeClass;
                break;
            case IDEA:
                EncryptionSchemeObject = new
                IDEAEncryptionSchemeClass;
                break;
            case AES128:
                EncryptionSchemeObject = new
                AES128EncryptionSchemeClass;
                break;
            ... ... ... // Can have many kinds of encryption
                        // schemes, not merely these six
            case AES256:
                EncryptionSchemeObject = new
                AES256EncryptionSchemeClass;
                break;
            case RSA:
                EncryptionSchemeObject = new
                RSAEncryptionSchemeClass;
                break;
            case ECC:
                EncryptionSchemeObject = new
                ECCEncryptionSchemeClass;
                break;
        } // end switch( )
        return EncryptionSchemeObject;
    } // end createEncryptionScheme( )
} // end class EncryptionSchemeFactory
```

The factory class for encryption schemes implements the parameterized factory method, createEncryptionScheme(ES-Type). CreateEncryptionScheme( ) accepts as a parameter a type code identifying the kind of encryption scheme to instantiate. That is, the type code, ‘ES-Type’ indicates the type of encryption selected by a user in response to a prompt from a foundry asking for user selection of an encryption scheme. CreateEncryptionScheme( ) operates a switch( ) statement in dependence upon ES-Type to decide which encryption scheme class to instantiate. Although only six encryption schemes are illustrated in the pseudocode factory class for encryption schemes, in fact the encryption scheme factory can create and return to the calling foundry an encryption scheme object, or a reference to such an object, for any type of encryption scheme supported by the security system in which it is installed, that is, any type of security scheme defined in any concrete encryption scheme class.

Concrete encryption scheme classes can be derived from abstract classes as shown by the following pseudocode abstract encryption scheme class:

```
//
// abstract EncryptionSchemeClass
//
Abstract Class EncryptionSchemeClass {
    private Key SecretKey;
    public void generateSecretKey( );
    public void setSecretKey( );
    public resourceID encrypt(unencryptedResourceID);
    public resourceID decrypt(encryptedResourceID);
}
```

The pseudocode abstract encryption scheme class provides storage ‘SecretKey’ for a secret key and a function named ‘generateSecretKey( )’ for automatic generation of secret keys, for example, by use of a random number generator. The pseudocode abstract encryption scheme class provides a set function ‘setSecretKey( )’ for application code that wishes to create a secret key externally, for example, by prompting a user for one. The pseudocode abstract encryption scheme class provides a secret key encryption function ‘secretKeyEncrypt( )’ and a secret key decryption function ‘secretKeyDecrypt( ).’

The pseudocode abstract encryption scheme class comprises an object oriented interface, declaring member methods and member data elements to be defined in concrete encryption scheme subclasses. The use of abstract classes provides a foundation for polymorphic calls from security objects, such as, for example, the call to

anEncryptionScheme.encrypt(aResourceID));

and to

anEncryptionScheme.decrypt(aResourceID));

in the exemplary security class described in more detail below in this disclosure.

These calls are polymorphic in that the security class that calls them neither knows nor cares what kind of encryption they implement.

Encryption scheme objects are instantiated from concrete encryption scheme classes, not from abstract encryption scheme classes. Concrete encryption scheme classes are derived by inheritance from abstract encryption scheme classes. Here are examples of concrete encryption scheme classes that can be instantiated as actual encryption schemes by, for example, a factory method such as

EncryptionSchemeFactory.createEncryptionScheme( ).

```
//
// concrete encryption scheme class for DES
//
class DESEncryptionSchemeClass : EncryptionSchemeClass {
    private Key SecretKey;
    public void generateSecretKey( ){
        SecretKey = rand( );
    }
    public void setSecretKey(aSecretKey){
        SecretKey = aSecretKey
    }
    public EncryptedResourceID encrypt(unencryptedResourceID){
        // program code for DES encryption
    }
    public DecryptedResourceID decrypt(encryptedResourceID){
        // program code for DES decryption
    }
}
```

DESEncryptionSchemeClass defines a class that can actually be instantiated as an encryption scheme object. DESEncryptionSchemeClass defines storage ‘SecretKey’ for a secret key, a secret key generating function ‘generateSecretKey( )’ that uses a random number generator, a function ‘setSecretKey( )’ for setting a secret key provided by outside application code, an implementation of a DES encryption algorithm in encrypt( ), and an implementation of a DES decryption algorithm in decrypt( ). Notice that the names of the interface functions does not change from the abstract encryption scheme class, thereby supporting polymnorphic calls for encryption and decryption from application code or security object code that does not know or care what kind of encryption scheme is used.

A concrete encryption scheme instantiated from DESEncryptionSchemeClass is useful, for example, in implementing encryption (608) according to the method of FIG. 2a for establishing (628) a secret key (616) out of band (630). The following example of a concrete encryption scheme, DES-RSAEncryptionSchemeClass, is useful also for implementing encryption (608) according to the method of FIG. 2b, using a public key (614) from a client device (102) to establish a secret key(616).

```
//
// concrete encryption scheme class for
// secret key encryption with DES and
// private key encryption with RSA
//
class DES-RSAEncryptionSchemeClass : EncryptionSchemeClass {
    private Key SecretKey;
    public void generateSecretKey( ){
        SecretKey = rand( );
    }
    public void setSecretKey(aSecretKey){
        SecretKey = aSecretKey
    }
    private Key ClientPublicKey;
    private Key ClientPrivateKey;
    private Key generatePublicRSAKey( );
    private Key generatePrivateRSAKey( );
    public EncryptedResourceID encrypt(unencryptedResourceID){
        ClientPublicKey = getPublicKey( );
        SecretKey = generateSecretKey( );
        EncryptedSecretKey = RSA-Encrypt(SecretKey,
        ClientPublicKey);
        ClientDeviceNetworkAddress = getClientAddress( );
        Send(EncryptedSecretKey, ClientDeviceNetworkAddress);
        // program code for DES encryption of the resource
    }
    public DecryptedResourceID decrypt(encryptedResourceID){
        // program code for DES decryption
    }
    public DecryptedResourceID decryptRSA(encryptedResourceID){
        // program code for RSA decryption with ClientPrivateKey
    }
}
```

Again, the names of the interface functions, encrypt( ) and decrypt( ), are unchanged from the abstract encryption scheme class, thereby supporting polymorphic calls for encryption and decryption from application code or security object code that does not know or care what kind of encryption scheme is used. In DES-RSAEncryptionSchemeClass, however, the interface function ‘encrypt( )’ is expanded to support the method of FIG. 2b, establishing a secret key with public key encryption. That is, DES-RSAEncryptionSchemeClass encrypt( ) includes a call to getPublicKey( ) to obtain a public key from a client device. Encrypt( ) then generates (650) a secret key (616) and uses the public key (614) to encrypt (618) the secret key with the RSA public key encryption algorithm:

EncryptedSecretKey=RSA-Encrypt(SecretKey, ClientPublicKey);

Encrypt( ) calls its environment for the client device's network address:

ClientDeviceNetworkAddress=getClientAddress( );

Encrypt( ) transmits the encrypted secret key to the client device and proceeds with processing by using the secret key for DES encryption of a resource.

In this example of the method according to FIG. 2a, the client device has in its possession an encryption scheme instantiated from DES-RSAEncryptionSchemeClass. The client device previously generated (612) public and private RSA keys, identified in this example by ClientPublicKey and ClientPrivateKey, through calls to generatePublicRSAKey( ) and generatePrivateRSAKey( ) respectively. The client device made its public key available to the security object for use in encrypting the secret key.

When the client device receives the encrypted secret key, the client device decrypts (620) the secret key by RSA decryption with its private key (615). In the pseudocode example, the decrypt( ) function is dedicated to DES decryption, so DES-RSAEncryptionSchemeClass provides an RSA decryption function named decryptRSA( ) for RSA decryption with the private key. When the client device receives the information (606) encrypted by DES secret key encryption (626) using the secret key (616), the client device decrypts the information by DES decryption (621) with the secret key (616).

Security objects themselves can be implemented, for example, according to the following pseudocode security class.

```
//
// SecurityClass ...
// a class from which security objects can be instantiated
//
Class SecurityClass
{
    private Resource aResourceID;
    public void setResourceID(resourceID) {
        aResourceID = resourceID
    }
    char anAuthorizationLevel;
    public void setAuthorizationLevel(authorizationLevel) {
        anAuthorizationLevel = authorizationLevel
    }
    EncryptionScheme anEncryptionScheme;
    public void setEncryptionScheme(someEncryptionScheme) {
        anEncryptionScheme = someEncryptionScheme;
    }
    public EncryptionScheme getEncryptionScheme( ) {
        return anEncryptionScheme;
    }
    // list of security control objects (references, actually)
    private List aList = new List( );
    // method for adding Security Control Objects to the List
    public void add(SCO) {
        aList.add(SCO);
    }
    // validate requests for access against all SCOs in the list
    // and encrypt or decrypt a resource
    public boolean main(accessType)
    {
        SCO = aList.getFirst( );
        while(SCO != null)
        {
            if((SCO.validate( )) != true) {
                denyAccess( );
                return false;
            }
            SCO = aList.getNext( );
        }
        // all SCOs in the List are now validated
        // encrypt or decrypt resource as needed
        if(accessType == ‘read’) {
            EncryptedResourceID =
            anEncryptionScheme.encrypt(aResourceID));
        }
        if(accessType == ‘write’) {
            DecryptedResourceID =
            anEncryptionScheme.decrypt(aResourceID));
        }
        grantAccess(EncryptedResourceID, accessType,
            anAuthorizationLevel);
        return true;
    } // end validate( )
} // end SecurityClass
```

The security class provides a storage location for a resource identification (312) named ‘resource ID,’ as well a member method named setResourceID( ) for storing (302) the resource identification. Similarly, the security class provides a field for authorization level and a method for storing (304) authorization level.

The security class provides storage for a reference to an encryption scheme, a concrete encryption scheme object: EncryptionScheme anEncryptionScheme. The security object provides a set functions for associating an encryption scheme with the security object:

public void setEncryptionScheme(someEncryptionScheme) { anEncryptionScheme=someEncryptionScheme; }

The security object provides a get functions for retrieving from the security object a reference to an associated encryption scheme:

public EncryptionScheme getEncryptionScheme( ) { return anEncryptionScheme; }

The exemplary pseudocode security class provides storage in the form of a list for storing security control objects. In C++, it would be possible to store security control objects as such, but in typical embodiments, the list is used to store security control objects as references.

The security class includes a method, addSCO( ) for adding a security control object to the list. The methods aList.add( ), aList.getFirst( ), and aList.getNext( ) are member methods in a list object that effectively operate a list object as an iterator. An ‘iterator’ is a conventional object oriented design pattern that supports sequential calls to elements of an aggregate object without exposing underlying representation. In this example, main( ) assumes that aList.getNext( ) returns null upon reaching the end of the list. It is common also, for example, for list classes to support a separate member method called, for example, ‘isDone( ),’ to indicate the end of a list. Any indication of the end of a list as will occur to those of skill in the art is well within the scope of the present invention.

In addition, the exemplary pseudocode security class includes a member method, main( ), that validates security access data in turn for each security control object in the list and encrypts a resource as needed. In this particular example, the validation method is called ‘main( )’ to support implementing security objects in Java, so that the validation method can be called by a call to the object name itself. On the other hand, when SecurityClass is implemented as a Java servlet, there is no requirement for a member method named ‘main( ),’ because, although servlets also are invoked by use of the class name itself, the interior interface requirements for servlets are different. When SecurityClass is implemented as a Java servlet, therefore, the name of the member method ‘main( )’ is changed to implement a member method signature from the standard Java servlet interface, such as, for example:

public void service(ServletRequest req, ServletResponse res).

The validation method main( ) operates by obtaining from the list each security control object in turn and calling in each security control object the interface member method ‘validate( ).’ As described in detail above, the validate( ) method in each security control object prompts for security access data, compares security access data to security control data, and return true or false according to whether the comparison succeeds or fails. SecurityClass.main( ) operates by denying access and returning false if validation fails for any security control object in the list. SecurityClass.main( ) grants access and return true if validation succeeds for all security control objects in the list.

SecurityClass.main( ) provides encryption as needed. In this example:

```
// encrypt resource as needed
if(accessType == ‘read’) {
    EncryptedResourceID =
    anEncryptionScheme.encrypt(aResourceID));
}
```

the need for encryption is illustrated by ‘read’ access, useful when a resource or information from a resource is to be transmitted over a network from a server to a client device.

SecurityClass.main( ) also provides decryption. In this example:

if(accessType==‘write’) { EncryptedResourceID=anEncryptionScheme.decrypt(aResourceID)); }

the need for encryption is illustrated by ‘write’ access to a resource, which is useful when an encrypted form of a resource or information for a resource has been transmitted over a network from a client device.

Although in this example, encryption and decryption are illustrated with resources or information for or from resources, it is also true that security methods such as SecurityClass.main( ) also can provide encryption and decryption for security request data as well. In security methods according to this example that provide encryption for security request data, calls to encryption scheme functions are advantageously implemented from security control objects. An example of a security control class implementing such calls to encryption scheme functions is the password security control class described above in this disclosure which calls a decryption method in an encryption scheme object identified for it through a parameter in its validate( ) method. In embodiments that utilize encryption of security request data, security control objects are therefore typically passed references to the pertinent encryption scheme by modifying the call to the security control objects so that it is parameterized with a reference to the encryption scheme:

if((SCO.validate(anEncryptionScheme)) !=true).

If SecurityClass.main( ) grants access, the access granted has the authorization level set by the member method setAuthorizationLevel( ). More particularly, in the method of FIG. 2, providing (220) access (222) includes authorizing a level of access in dependence upon the authorization level of access for the resource (314 on FIG. 3). In the example of security objects implemented to accept calls from hyperlinks in web pages displayed in browsers on client devices located remotely across a network, the security objects themselves often are implemented as servlets or CGI programs that administer HTTP GET and PUT request messages. In such exemplary embodiments, a security object granting access to a resource having only ‘read’ authorization level would honor a GET request by transmitting to the client browser a copy of the resource in HTML. The same exemplary security object, however, would not honor a PUT request for writing data to the resource.

FIG. 4 sets forth a class relations diagram summarizing exemplary relations among classes and objects useful in various embodiments of the present invention. As shown in FIG. 4, in many embodiments, concrete security classes (107), from which security objects are instantiated, are subclasses that inherit from abstract security classes (402). Similarly, concrete security control classes (315), from which security control objects are instantiated, are subclasses that inherit from abstract security control classes (404). And concrete encryption scheme classes (636), from which encryption scheme objects are instantiated, are subclasses that inherit from abstract encryption scheme classes (634).

In addition, it is useful to remember that ‘abstract,’ as the term is used here to describe classes, is used in support of interface definition, in a fashion similar to its use in the terminology of C++. In Java, some structures that here are called abstract classes would be called ‘interfaces,’ as such, the ones containing no function definitions. No doubt such structures have other names in other environments, but here in this disclosure they are called ‘abstract classes’ and used to illustrate declarations of object oriented interfaces.

Foundries (224) are shown in FIG. 4 as classes having references to security factory classes (406) and concrete security classes (107). The security factory (406) of FIG. 4 is illustrated with a member method, a factory method named ‘createSCO( )’ (408). Foundries (224), as described in detail above, cooperate with security factories (406) and security objects instantiated from concrete security classes (107) by passing to security objects references to security control objects for inclusion in security control object lists (318). The arrow (412) can be drawn between concrete security classes (107) and concrete security control classes (315), indicating that a security class ‘has a’ security control class, because the reference needed to implement the object oriented ‘has a’ relationship is provided to the security class by a foundry (224) for storage in a security control object list (318).

Foundries (224) are shown in FIG. 4 as classes having references to encryption scheme factory classes (638) and concrete security classes (107). The encryption scheme factory (638) of FIG. 4 is illustrated with a member method, a factory method named ‘createEncryptionScheme( )’ (640). Foundries (224), as described in detail above, cooperate with encryption scheme factories (638) and security objects instantiated from concrete security classes (107) by passing to security objects references to concrete encryption scheme objects. The arrow (642) can be drawn between security classes (107) and concrete encryption scheme classes (636), indicating that a security class ‘has a’ concrete encryption scheme class, because the reference needed to implement the object oriented ‘has a’ relationship is provided to the security class by a foundry (224).

Security control object lists (318) are often implemented as container objects from a standard library in, for example, C++ or Java. That is, a security control object list (318) is typically a class object aggregated by reference to a security object instantiated from a security class (108). With member methods (410) such as add( ), getFirst( ), and getNext( ), a security control object list (318) often can function as a so called ‘iterator,’ greatly easing manipulation of security control objects on behalf of a security object. Iterator operations are illustrated in the pseudocode above for SecurityClass.

Again referring to FIG. 2, the illustrated method includes deploying (226) a security object. Security objects can be created (206) on a client device and deployed (226) to a client device (102), including the same client device on which the security object is created, or to a server (106). Security objects can be created (206) on a server and deployed (226) to a server (I 06), including the same server on which the security object is created, or to a client device (102). Deployment can be local, that is, within the same client device or server, or within a trusted LAN.

Deployment can be remote, that is, across public networks, such as, for example, the Internet or the World Wide Web. One advantageous mode of remote deployment, for example, is a download of a security object implemented as a Java applet to a Java-enabled web browser. An applet is a Java program designed to be run from another program, such as a browser, rather than directly from an operating system. Because applets typically are small in file size, cross-platform compatible, and highly secure (can't be used to access users' hard drives), they are useful for small Internet applications accessible from a browser, including, for example, security objects according to the present invention.

More particularly, in some embodiments according to the method of FIG. 2, a resource (112) resides on a resource server (110), and the method includes deploying (226) the security object (108) on a security server (106) and receiving (208) the request for access to the resource in a security server (106) from a client device (102) across a network (202). Network (202), as mentioned above, can be any network, public or private, local area or wide area, wireless or wired. In embodiments according to this aspect of the invention, receiving (208) a request for access (210) is typically carried out through some form of remote procedure call, such as, for example, a hyperlink to a Java servlet, a hyperlink to a CGI function, a call to a member method in a CORBA object, a remote object call through a Java RMI interface, or a remote object call through a DCOM interface.

In a further aspect of the method of FIG. 2, a resource (112) resides on a client device (102), and the client device has an application program (120 on FIG. 1c) that accesses the resource. In this kind of embodiment, the method includes deploying (226) the security object (108) on the client device (102), effecting an architecture like the one shown in FIG. 1c. In this configuration, receiving (208) a request (210) for access to the resource (112) includes receiving (208) the request for access to the resource in the security object itself as a call to the security method (218). In some embodiments of this kind, in fact, a security object (108) can be compiled right into the client application (120), so that receiving a request for access is implemented as a conventional local function call, with no particular need for remote procedure calling methodologies such as those listed above—hyperlinks, CORBA, Java RMI, and so on.

In some embodiments of the present invention receiving (208) a request for access (210) to a resource (112) comprises a call to a security method (218) in a security object (108). Such direct calls can be implemented through Java, for example, by naming the security method (218) ‘main( )’ and issuing a call of the form ‘java SecurityObjectName.’ Alternatively, a call may be issued from a hyperlink in a browser to a security method in a security object implemented as a Java servlet by including in an HTTP request message a URI of the form:

http://ServerName/servlet/MySecurityObject

where MySecurityObject is the name of a security object implemented as a servlet and containing a security method named according to the conventions of the standard Java servlet interface, that is, for example, named ‘service( ).’

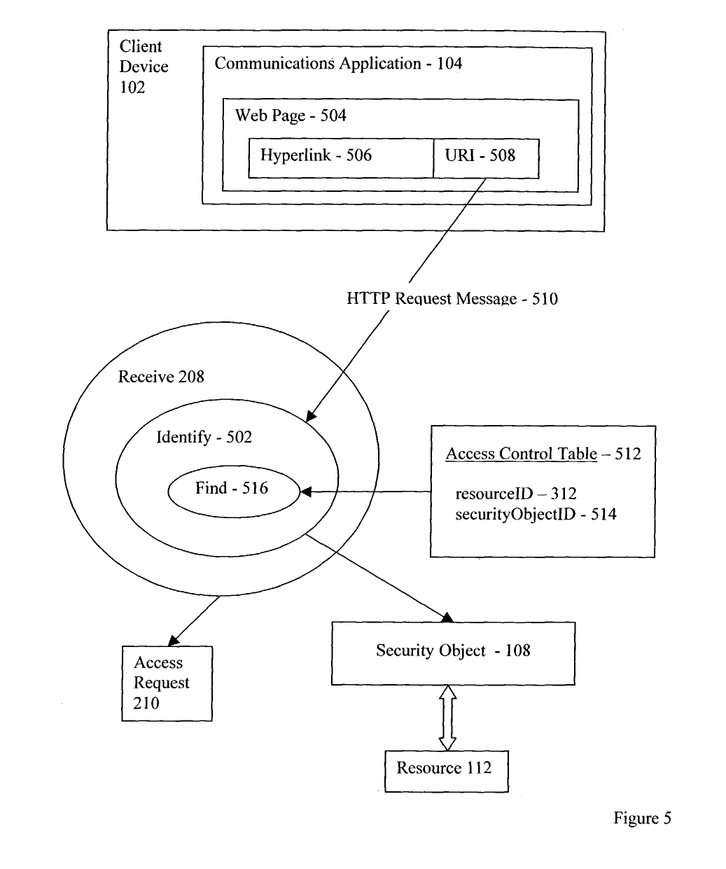

FIG. 5 sets forth a data flow diagram illustrating more detailed embodiments of receiving (208) a request (210) for access to a resource. In one method according to FIG. 5, receiving (208) a request (210) for access to a resource (112) includes identifying (502) a security object (108), that is, identifying a security object that controls access to the resource. Consider the example mentioned earlier of a security object (108) implemented as a Java servlet. In such an exemplary embodiment, identifying (502) the security object (108) comprises identifying the security object in dependence upon a URI (508). Typically, the URI (508) originates from a hyperlink (506) in a web page (504) in a communications application (104) in a client device (102). The communications application can be, for example, a browser in a client device that is a personal computer or a microbrowser in a client device that is a web-enabled cell phone. Such embodiments typically communicate the identification of the security object in the form of an HTTP request message containing the URI. The URI can have this form:

http:H/ServerName/servlet/MySecurityObject

from which a servlet-enabled server can invoke the security object as a servlet named MySecurityObject. The server does not invoke the security object in the sense of calling it as such. The server ‘invokes’ the security object in that the server calls a member method within the security object according to the conventions of the standard Java servlet interface. In this example, the identity of the security object was known to the calling application.

It is possible, however, that the calling application may know the identity of a resource without knowing the identity of the security object that controls access to the resource. In such an exemplary embodiment, a request for access to a secured resource may arrive in an HTTP request directed at a resource that is a document identified as:

http://ServerName/SomeoneElse'sFiles/Document123.

For use in such embodiments, in one method according to FIG. 5, identifying (502) the security object (108) includes identifying the security object in dependence upon a URI (508) that identifies the resource (112), including finding (516), in dependence upon the URI (508) identifying the resource (112), an identification (514) of the security object in an access control table (512).

Although in this example, where the access request came with a URL the identification (312) of the resource is, for example, a URI or a filename or pathname extracted from a URI. In embodiments of the invention generally, there is no requirement that the communications application be a browser or use HTTP for its communications. The resource identification (312) can be any digital identification, including for example, a filename or pathname communicated in a plaintext string or in cyphertext.

The identification (514) of the security object can be the security object name, for example, or, in the example where the security object is implemented as a Java servlet, the identification (514) of the security object can be a URI in the now familiar form:

http://ServerName/servlet/MySecurityObject.

In this kind of embodiment, a security server is programmed upon receiving a request for access, to check an access control table (512). In fact, this small change in the overall programming of the security server, is the only thing that makes it a ‘security server’ within the meaning of the present invention. The security server needs no other security-related service upon it. Security authentication and authorization are handled by the security object. All the security server needs to do is look up the identity of the security object and invoke it. ‘Invoke’ in this sense means to call the security method in the security object by, for example, a call to ‘java SecurityObjectName’ for a security object implemented as a standard Java class, a call to ‘http://ServerName/servlet/MySecurityObject’ for a security object implemented as a Java servlet, or a call to ‘SecurityObjectName’ for a security object implemented as a C++ program. If the security server can find no security object for the resource identified in a request for access, then the security server continues its normal operations. If the security server is programmed to grant access only upon finding a corresponding security object, then the security server denies access when no such object is found in the access control table. If the security server has other security services available upon it, then it is often programmed to apply them in its usual fashion.

Alternatively, if the security server has no other security services available upon it, it may be programmed to comply with HTTP request messages on their own terms according to whether they are GET messages, PUT messages, and so on. In other words, the security server can implement the standard operations of a web server. This implementation is a little riskier than the other two examples mentioned just above but it has the advantage of being very easy to implement, requiring as it does only one small change to the source code of a conventional web server just to do one lookup in an access control table and, if the lookup succeeds, invoke a security object identified in the lookup.

By this point in this disclosure, several advantages of using various embodiments of the present invention are clear. One advantage is pure flexibility, especially at the user level and the application level. Embodiments of the present invention can make foundry applications available to ordinary users, rather then just to system administrators. Any user can choose to associate with any resource any kind of security data supported in a security system. Users can decide for themselves whether they want just a plain text logon ID and/or something much more elaborate—a fingerprint, a voiceprint, a retinal scan, and so on. As a result, users can be given great freedom in defining the security content and security level for securing users' resources, much greater freedom than available to users in prior art systems.

Another advantage of security objects according to the present invention is that security servers, communications servers, resource servers such as document or application servers—none of the servers in networks need to have any particular concern with security beyond associating a security object with a resource. Moreover, as mentioned above, it is possible within the present invention to establish a regime in which all resources in a particular location are accessed only indirectly through security objects, in which case, a server providing access to such resources need have upon it no other security service whatsoever, at least as regards authentication and authority level. In particular, servers that administer access to resources need not be concerned with the type of security data provided by users or required to qualify for access to a resource.

Another advantage of the present invention relates to encryption. As described above, certain elements of security control data are advantageously stored in encrypted form. Persons seeking unauthorized access to resources may seek to decrypt such security control data. Such unauthorized access is made much more difficult by a need, easily established by any properly authorized user, to decrypt not only a single security control data element such as a password, but also to decrypt multiple security control data elements including fingerprints, retinal scans, voiceprints, and so on.

Another advantage of the present invention is the ease with which a user can arrange multiple access authorization for multiple users. A user authorized to do so, under the present invention, can simply create multiple security objects for a single resource and distribute, for example, a URI identifying each such separate security object to separate users. By such usage, a user can quickly grant with respect to a particular document, for example, ‘read’ access to Jane Smith, ‘read’ access to Joe Blow, ‘write’ access to Mike Walker, and reserve ‘execute’ access to the original user, the owner of the document. The security control data can be set differently in each of the separate security objects all of which point to the same document, therefore preventing Jane and Joe from using Mike's security object to gain access, even if they can gain access to Mike's security object.

Another advantage is reduction of security responsibility on the part of server system administrators. This advantage obtains because security objects of the present invention tend to upcast security control from communications protocols layers to application layers. “Layers” in this context refers to the standard data communications protocol stack in which the IP protocol resides in layer 3, the so called ‘network layer,’ and the Transmission Control Protocol, or “tcp,” resides in layer 4, the so called transport layer. In this context, SSL is considered a layer 4 security protocol, and the well known protocol for virtual private networking known as “IPSec” is considered a layer 3 protocol. In this disclosure, any functionality above layer 4 is described as residing in an ‘application layer.’ Therefore security objects according to the present invention are considered to be application layer software. As such, security objects and their operations in securing access to resources are completely transparent to systems administrators working on layer 4 or layer 3 security systems. In fact, it is possible to structure web servers as security servers, as mentioned above, so that such security servers have little or no concern regarding whether layer 4 or layer 3 security systems even exist at all. This is potentially a dramatic shift in security responsibilities for system administrators, including, for example, system administrators in Internet Service Providers or ‘ISPs.’

It will be understood from the foregoing description that various modifications and changes may be made, and in fact will be made, in the exemplary embodiments of the present invention without departing from its true spirit. The descriptions in this specification are for purposes of illustration only and are not to be construed in a limiting sense. The scope of the present invention is limited only by the language of the following claims.

What is claimed is:

1. A method of controlling access to a resource, the method comprising:
creating a security object in dependence upon user-selected security control data types, the security object comprising security control data and at least one security method;
receiving a request for access to the resource;
receiving security request data; and
providing access to the resource in dependence upon the security control data and the security request data,
wherein the resource comprises information, and providing access to the resource further comprises encrypting the information.

2. The method of claim 1 wherein creating a security object further comprises storing in the security object a user-selected encryption scheme.

3. The method of claim 1 wherein encrypting the information comprises:
establishing a secret key, and
encrypting the information with secret key encryption.

4. The method of claim 3 wherein establishing a secret key includes establishing the secret key out of band.

5. The method of claim 3 wherein establishing a secret key includes establishing the secret key with a public key.

6. The method of claim 1 wherein encrypting the information comprises downloading an encryption scheme from a security object to a client device.

7. The method of claim 1 further comprising encrypting the security request data.

8. A system for controlling access to a resource, the system comprising:
means for creating a security object in dependence upon user-selected security control data types, the security object comprising security control data and at least one security method;
means for receiving a request for access to the resource;
means for receiving security request data; and
means for providing access to the resource in dependence upon the security control data and the security request data,
wherein the resource comprises information, and the means for providing access to the resource further comprises means for encrypting the information.

9. The system of claim 8 wherein means for creating a security object further comprises means for storing in the security object a user-selected encryption scheme.

10. The system of claim 8 wherein means for encrypting the information comprises:
means for establishing a secret key, and
means for encrypting the information with secret key encryption.

11. The system of claim 10 wherein means for establishing a secret key includes means for establishing the secret key out of band.

12. The system of claim 10 wherein means for establishing a secret key includes means for establishing the secret key with a public key.

13. The system of claim 8 wherein means for encrypting the information comprises means for downloading an encryption scheme from a security object to a client device.

14. The system of claim 8 further comprising means for encrypting the security request data.

15. A computer program product for controlling access to a resource, the computer program product comprising:
a recording medium;
means, recorded on the recording medium, for creating a security object in dependence upon user-selected security control data types, the security object comprising security control data and at least one security method;
means, recorded on the recording medium, for receiving a request for access to the resource;
means, recorded on the recording medium, for receiving security request data; and
means, recorded on the recording medium, for providing access to the resource in dependence upon the security control data and the security request data,
wherein the resource comprises information, and the means for providing access to the resource further comprises means, recorded on the recording medium, for encrypting the information.

16. The computer program product of claim 15 wherein means for creating a security object further comprises means, recorded on the recording medium, for storing in the security object a user-selected encryption scheme.

17. The computer program product of claim 15 wherein means for encrypting the information comprises:
means, recorded on the recording medium, for establishing a secret key, and
means, recorded on the recording medium, for encrypting the information with secret key encryption.

18. The computer program product of claim 17 wherein means for establishing a secret key includes means, recorded on the recording medium, for establishing the secret key out of band.

19. The computer program product of claim 17 wherein means for establishing a secret key includes means, recorded on the recording medium, for establishing the secret key with a public key.

20. The computer program product of claim 15 wherein means for encrypting the information comprises means, recorded on the recording medium, for downloading an encryption scheme from a security object to a client device.

21. The computer program product of claim 15 further comprising means, recorded on the recording medium, for encrypting the security request data.
